(19) United States
(12) Patent Application Publication
(10) Pub. No.: US 2025/0045610 A1
(43) Pub. Date: Feb. 6, 2025

(54) TEAM MODELING VIA DECENTRALIZED THEORY OF MIND REASONING

(71) Applicant: SRI International, Menlo Park, CA (US)

(72) Inventors: Pedro Daniel Barbosa Sequeira, Palo Alto, CA (US); Haochen Wu, Ann Arbor, MI (US)

(21) Appl. No.: 18/673,036

(22) Filed: May 23, 2024

Related U.S. Application Data
(60) Provisional application No. 63/468,731, filed on May 24, 2023.

(51) Int. Cl. G06N 7/01; G06N 5/043

(52) U.S. Cl. CPC G06N 7/01; G06N 5/043

(57) ABSTRACT

In an example, a method includes obtaining data indicating a plurality of trajectories representing a behavior of a team comprising a plurality of agents; obtaining a plurality of baseline profiles, wherein each of the plurality of baseline profiles encodes at least one of a preference and/or a goal that is relevant to a task performed by the team; generating a probability distribution of each agent of the plurality of agents over the plurality of baseline profiles, wherein the probability distribution of each agent describes a behavior of the agent; updating the corresponding probability distribution of each agent of the plurality of agents; and generating, based on the updated probability distributions of the plurality of agents, reward functions that explain the observed joint actions performed by the team, wherein each of the reward functions describes the behavior of a corresponding one of the plurality of agents.

This application claims the benefit of U.S. Patent Application 63/468,731, filed May 24, 2023, which is incorporated by reference herein in its entirety.

### GOVERNMENT RIGHTS

This invention was made with Government support under contract number W911NF2010011 awarded by the Army Research Office (ARO)/Defense Advanced Research Projects Agency (DARPA). The Government has certain rights in this invention.

### TECHNICAL FIELD

This disclosure is related to machine learning systems, and more specifically to team modeling via decentralized theory of mind reasoning.

### BACKGROUND

Recent advancements in Artificial Intelligence (AI) may significantly improve collaboration between humans and computers for complex tasks. Human teams often underperform due to: individual variations, lack of familiarity with teammates, and evolving dynamics. People have different strengths and weaknesses. Biases may arise when collaborators do not know each other well. As relationships change, people may need to adapt their approach. AI may offer several advantages: generating optimal Courses of Action (COA), reasoning about uncertainty, learning from observation. AI may analyze data to identify the best options for achieving a shared goal.

### SUMMARY

In general, techniques are described for utilizing Multiagent Inverse Reinforcement Learning (MIRL) with Theory of Mind (ToM) to reason about behaviors of teammates during a task. The disclosed techniques provide a decentralized approach in which the reward functions for each team member are learned individually. In general, MIRL aims to recover the reward functions of multiple agents by observing their past trajectories. By analyzing these trajectories, MIRL tries to understand what motivates the actions of each agent. ToM refers to the ability to understand and attribute mental states (beliefs, desires, motivations, intentions) to others. In some examples, ToM reasoning is employed to interpret actions of one or more teammates by considering their potential goals and motivations.

Instead of having a single reward function for the entire team, the disclosed techniques learn a reward function for each team member separately. These decentralized techniques allow for individual motivations and goals to be accounted for. As used herein, a set of baseline agent profiles may represent a set of predefined “personalities” or behavioral tendencies for agents in a specific domain. The baseline agent profiles may encode general preferences and goals that might be relevant to the task. The baseline agent profiles may be used as pre-built “templates” for agent motivations.

For example, in a disaster relief scenario, the following profiles may be used: profiles for searching for victims in collapsed buildings, requesting for medical personnel to triage and evacuate victims, communicating existing road blockages to the police, and so on. The baseline agent profiles may be easier to define than individual reward functions. The baseline agent profiles may encapsulate domain-specific preferences. Generally, the baseline agent profiles may be based on any agent decision-making model, but the disclosed techniques may represent the baseline agent profiles by pre-defined reward functions (reward profiles). The reward profiles may specify rewards for achieving specific goals and may specify penalties for incurring losses. For example, the reward profiles may specify a high reward for rescuing a victim, and/or a penalty for failing to communicate a roadblock.

The disclosed MIRL-ToM techniques may include two phases: model inference and decentralized MIRL. The model inference phase may employ Bayesian ToM reasoning to continuously update the beliefs of each agent (probability distributions) about the baseline profiles that best describe the observed behavior of one or more teammates. As described herein, the Bayesian ToM reasoning may essentially capture how agents “read the minds” of their teammates based on actions of their teammates in the observed trajectories. Put another way, the model inference phase allows the learning of a sequence of distributions of the baseline profiles (models) of other agents, which essentially captures how agents might have modeled one another by observing their behavior during task performance. This then allows the encoding of the ToM reasoning process of the experts during the reward function learning/IRL phase to produce simulated behavior to be compared against observed behavior. (In inverse reinforcement learning (IRL), an expert refers to a human or agent whose behavior is used as a demonstration or example to learn a reward function.) After the agents update their beliefs about motivations of their teammates (model inference phase), the disclosed MIRL-ToM techniques may perform decentralized MIRL by computing a reward function for each individual agent separately.

The described techniques may provide one or more technical advantages that realize one or more practical applications. For example, the model inference phase in which ToM reasoning is used to estimate a posterior distribution over baseline reward profiles, given agents' demonstrated behaviors, may improve MIRL to account for imperfect knowledge about agents' behavior and uncertain strategies of other agents. The techniques may also enable a computationally efficient approach to compute the equilibrium strategy in a decentralized manner. The term “equilibrium,” as used herein refers to a joint/team strategy, where no teammate can improve their outcome without making at least one other teammate worse off. In addition, the MIRL-ToM techniques described herein have experimentally shown the ability to recover similar behavior in terms of trajectory feature counts in both known- and unknown-teammate cases. Example use cases for the techniques may include the use of learned team models for decision aids to, e.g., improve team performance, plan re-training of teams, allocate tasks and resources, or build collaborative AI (CAI) agents that dynamically adapt to (human/non-human) teammates from observed behavior as tasks unfold. Teams can include a mix of human and artificial intelligence-based members.

In an example, a method for team modeling includes obtaining data indicating a plurality of trajectories representing a behavior of a team comprising a plurality of agents; obtaining a plurality of baseline profiles, wherein each of the plurality of baseline profiles encodes at least one of a preference and/or a goal that is relevant to a task performed by the team; generating, based on the data indicating the plurality of trajectories, a probability distribution of each agent of the plurality of agents over the plurality of baseline profiles, wherein the probability distribution of each agent describes a behavior of the agent; updating, based on one or more observed joint actions performed by the team, the corresponding probability distribution of each agent of the plurality of agents; and generating, based on the updated probability distributions of the plurality of agents, one or more reward functions that explain the observed one or more joint actions performed by the team, wherein each of the one or more reward functions describes the behavior of a corresponding one of the plurality of agents.

In an example, a system for team modeling includes processing circuitry in communication with storage media, the processing circuitry configured to: obtain data indicating a plurality of trajectories representing a behavior of a team comprising a plurality of agents; obtain a plurality of baseline profiles, wherein each of the plurality of baseline profiles encodes at least one of a preference and/or a goal that is relevant to a task performed by the team; generate, based on the data indicating the plurality of trajectories, a probability distribution of each agent of the plurality of agents over the plurality of baseline profiles, wherein the probability distribution of each agent describes a behavior of the agent; update, based on one or more observed joint actions performed by the team, the corresponding probability distribution of each agent of the plurality of agents; and generate, based on the updated probability distributions of the plurality of agents, one or more reward functions that explain the observed one or more joint actions performed by the team, wherein each of the one or more reward functions describes the behavior of a corresponding one of the plurality of agents.

In an example, non-transitory computer-readable storage media having instructions encoded thereon, the instructions configured to cause processing circuitry to: obtain data indicating a plurality of trajectories representing a behavior of a team comprising a plurality of agents; obtain a plurality of baseline profiles, wherein each of the plurality of baseline profiles encodes at least one of a preference and/or a goal that is relevant to a task performed by the team; generate, based on the data indicating the plurality of trajectories, a probability distribution of each agent of the plurality of agents over the plurality of baseline profiles, wherein the probability distribution of each agent describes a behavior of the agent; update, based on one or more observed joint actions performed by the team, the corresponding probability distribution of each agent of the plurality of agents; and generate, based on the updated probability distributions of the plurality of agents, one or more reward functions that explain the observed one or more joint actions performed by the team, wherein each of the one or more reward functions describes the behavior of a corresponding one of the plurality of agents.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 illustrates an exemplary collaborative team environment, in accordance with the techniques of the disclosure.

FIG. 2 is a detailed block diagram illustrating an example computing system, in accordance with the techniques of the disclosure.

FIG. 3 is a conceptual diagram illustrating an overview of Multiagent Inverse Reinforcement Learning via Theory of Mind reasoning (MIRL-ToM) framework according to techniques of this disclosure.

FIG. 4 is a conceptual diagram illustrating two phases of the MIRL-ToM framework, according to techniques of this disclosure.

FIG. 5 is a conceptual diagram illustrating learning techniques of multiple agents (a “team”) to cooperate and achieve a common goal based on expert demonstrations, according to techniques of the present disclosure.

FIG. 6 is a flowchart illustrating an example mode of operation for a machine learning system, according to techniques described in this disclosure.

Like reference characters refer to like elements throughout the figures and description.

### DETAILED DESCRIPTION

If AI systems are to function well in collaborative environments alongside humans, the AI systems need to understand how people interact and cooperate. By understanding collaborative strategies, AI systems may better predict how humans will behave in a team setting. AI systems may learn the underlying dynamics of human collaboration, like communication, role allocation, and decision-making. With understanding collaboration dynamics, AI systems may potentially assist human teams by: identifying potential problems or inefficiencies and/or suggesting strategies or communication methods to improve performance. When people are encountering new teammates, there might be limited initial knowledge about each other's goals, strategies, and intentions. Despite this initial lack of knowledge, successful collaboration may require agents to adapt to different styles of other agents (teammates) as the interaction progresses.

One approach to predict individual behavior in a task using machine learning focuses on creating a model that maps directly from observed states (situations) to actions taken by individuals. Approaches like behavior cloning may use past behavior data to train the machine learning model, essentially mimicking observed actions without needing a deep understanding of the agent's behavior itself. Behavior cloning may accurately replicate observed behaviors, making it useful for tasks where mimicking specific actions is desirable. Such models typically do not capture the underlying intentions or goals of individuals. The behavior cloning machine learning models simply replicate observed actions without understanding the “why” behind the observed actions. In collaborative settings, predicting individual actions alone may not be enough. The behavioral cloning machine learning models would not be able to understand how people coordinate or identify and correct potential issues like conflicting preferences.

An alternative Reinforcement Learning (RL) approach assumes individuals performing the task are like agents. In RL, agents may learn through trial and error interactions with their environment. The goal of each agent may be to maximize a reward function that encodes their preferences in the task. Given observed behavior of an individual (considered the “expert”), Inverse Reinforcement Learning (IRL) aims to recover the reward function that guided their actions. Understanding the reward function may be like understanding the underlying motivations or strategy in the task of an individual. The reward function may be a more succinct and robust way to capture the goals of an expert compared to a full policy mapping states to actions. By understanding the reward function, IRL may predict behavior in novel situations or different tasks where the underlying goals may still be relevant.

The core challenge with IRL is that IRL may be ill-posed. In other words, the same observed behavior may be explained by multiple different reward functions. Additionally, the same reward function may lead to different behaviors depending on the environment (stochastic dynamics). Despite the aforementioned challenge, various IRL approaches have been developed.

Apprenticeship learning approach uses linear programming to match a learned reward model with the observed behavior of an expert. The apprenticeship learning approach focuses on state-action pairs from the demonstrations of an expert. Game theoretic approach may learn even without an expert by analyzing repeated games. The game theoretic approach assumes some form of competition or interaction between agents.

Maximum Margin IRL (MMIRL) approach formulates the problem as a mathematical optimization task. The MMIRL approach aims to find a reward function that makes the observed behavior of an expert more likely compared to other possible behaviors. Recognizing the inherent ambiguity in IRL, some approaches use probabilistic formulations. Maximum Entropy (MaxEnt) IRL technique seeks a distribution of trajectories where the demonstrations of an expert are highly probable. The MaxEnt IRL technique leverages the principle of maximum entropy to find a reward function that does not make any unnecessary assumptions about other possible behaviors. Bayesian IRL technique uses a more efficient sampling approach to infer the probability distribution of the reward function parameters. Such sampling approach may allow for a more nuanced understanding of the potential reward functions that could explain the observed behavior.

As discussed previously, IRL may recover the reward function (underlying motivations) of an individual based on their observed behavior. Multiagent Inverse Reinforcement Learning (MIRL) technique extends IRL to analyze observed team behavior. The goal of MIRL is to infer the individual reward functions of each team member by observing the joint behavior of a team during a task. Unlike single-agent IRL, MIRL faces additional challenges.

Typical MIRL assumption is that the behavior of a team reflects an equilibrium solution concept, like a Nash Equilibrium (where each team member acts in their own best interest). Just like in single-agent IRL, there may be multiple reward functions that explain the observed team behavior. Furthermore, different combinations of individual reward functions may lead to the same team equilibrium behavior, making it even harder to pinpoint unique reward functions for each team member.

Several of the examples described herein provide techniques for creating and managing collaborative working teams using a team management module (e.g., a team management machine learning system) or a team management logic unit. In some examples, a collaborative team may be created by creating an association between team members (also referred to herein as “agents”) and the collaborative tasks (e.g., search and rescue tasks) associated with the collaborative team. In some examples, a team member on a particular team may also be a member of any number of other teams. The associations between teams and team members may be mapped and used for efficient task management. In some examples, the team may be a hybrid team consisting of both one or more human and one or more AI agents. In some examples, there may be no centralized team management module.

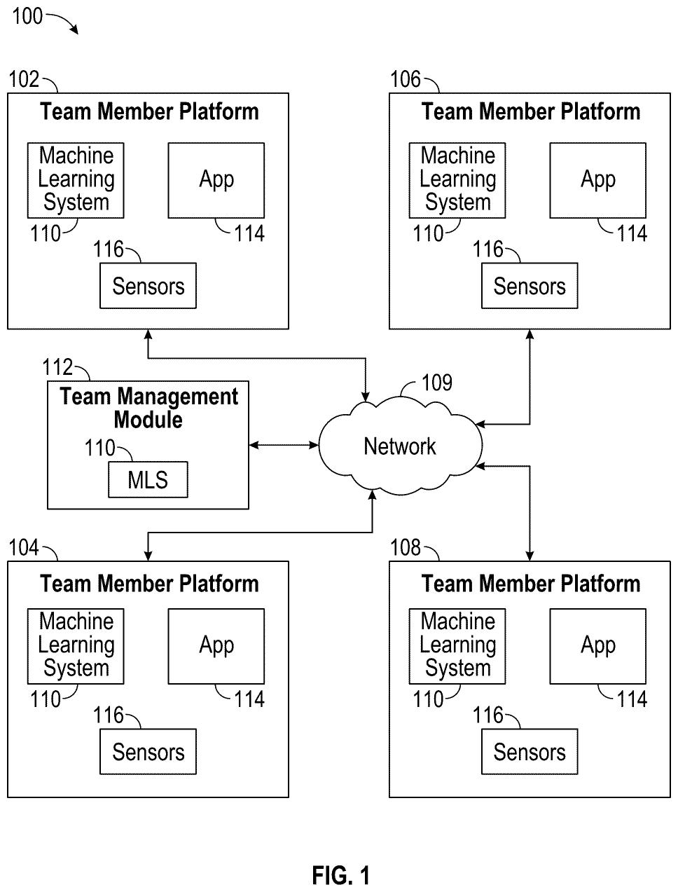

In some examples, each team may be associated with one or more collaborative team tasks related to a team project. For example, FIG. 1 depicts an exemplary collaborative team environment 100 through which a plurality of collaborative tasks may be performed. The collaborative team environment 100 may include a team management module 112 in communication with one or more team member platforms 102, 104, 106, and 108 having one or more machine learning systems 110. In some examples, team management module 112 may be in communication with the one or more team member platforms 102, 104, 106, and 108 via any type of a general or specific communication network 109. Communication network 109 may be any communication network, including any wired and/or wireless communication technologies, wired and/or wireless communication protocols, and the like. Communication network 109 may be any communication network that communicatively couples a plurality of computing devices and storage devices in such a way as to computing devices to exchange information via communication network 109.

Each team member platform 102, 104, 106, and 108 may be a machine (e.g., AI agent) or a device (e.g. mobile device) having machine learning system 110 and one or more applications 114 through which a team member may work on any team project. The one or more applications 114 of each team member platform 102, 104, 106, and 108 may be any application that a team member may use to perform any task. Each team member platform 102, 104, 106 and 108 may include any number and type of application 114. In some examples, the applications 114 may be in communication with one another such that activity by a team member within one application may impact activity within another application. It should be noted that in some examples, each team member platform 102 may include one or more sensor(s) 116. The one or more sensors 116 may include but are not limited to: one or more ultrasonic sensors, one or more RADAR sensors, one or more LiDAR sensors, one or more surround cameras, one or more stereo cameras, one or more infrared cameras, a GPS unit that provides location coordinates, and so on. Sensor data generated by one or more sensors 116 may include image data, relative position data, absolute position data, temperature, audio data, motion, pressure, proximity, light, electrical, vibration, or other data. In an aspect, one or more sensors 116 may record behavior (e.g. performed actions) of the one or more team members associated with the team member platform 102, 104, 106, and 108. In some examples, each team member platform 102, 104, 106, and 108 may transmit the collected sensor data to one or more other team member platforms and/or to the team management module 112. In some examples, team management module 112 may analyze, using the machine learning system 100, the behavior of the team, as described below, based on the received sensor data.

The collaborative team environment 100 may have any number of team member platforms 102, 104, 106, and 108. For example, a team having four team members may include four team member platforms, which the team management module 112 may associate with one another and manage. Additionally, the team management module 112 may manage any number of teams having any number of team member platforms associated with each team.

In accordance with techniques of this disclosure, machine learning system 110 of each team member platform 102, 104, 106 and 108 and of team management module 112 may obtain data capturing the team's actions over time. This data may be represented as a sequence of state-joint action pairs. Each state may describe the environment at a particular point in time (e.g., robot positions, object locations). Joint action may represent the actions taken by all agents (e.g., team member platform 102, 104, 106 and 108) at that time (e.g., movement of each robot). Machine learning system 110 may collect a plurality of trajectories. In other words, there may be multiple instances of the team performing the task. Baseline profiles may represent potential motivations or goals for the individual agents. Baseline profiles may encode preferences (e.g., minimizing energy expenditure) or goals (e.g., reaching a specific location). A set of baseline profiles may include multiple profiles, each capturing a different possible motivation. For each agent, machine learning system 110 may generate a probability distribution over the baseline profiles. The probability distribution may represent how likely the agent is to be driven by each potential motivation, Initially, this probability distribution may be uniform (all motivations equally likely) or based on prior knowledge. When the team performs a joint action (all agents acting together), machine learning system 110 may observe the resulting state change. The observed action may be compared to the predictions made by each agent's current probability distribution over motivations. If a predicted behavior of an agent based on its dominant motivation does not match the observed joint action, machine learning system 110 may determine the motivation might be wrong. Based on this comparison, the machine learning system 110 may update probability distribution for each agent. The probability of motivations that align well with the observed action may increase. The probability of motivations that poorly predict the action may decrease. After observing multiple team actions and updating the agent behavior distributions, machine learning system 110 may use them to infer reward functions. A reward function may define what outcomes are desirable for an agent. The generated reward functions may be based on the dominant motivations in the final probability distributions for each agent. The generated reward functions may essentially represent what each agent “values” most within the team task, based on the observed behavior.

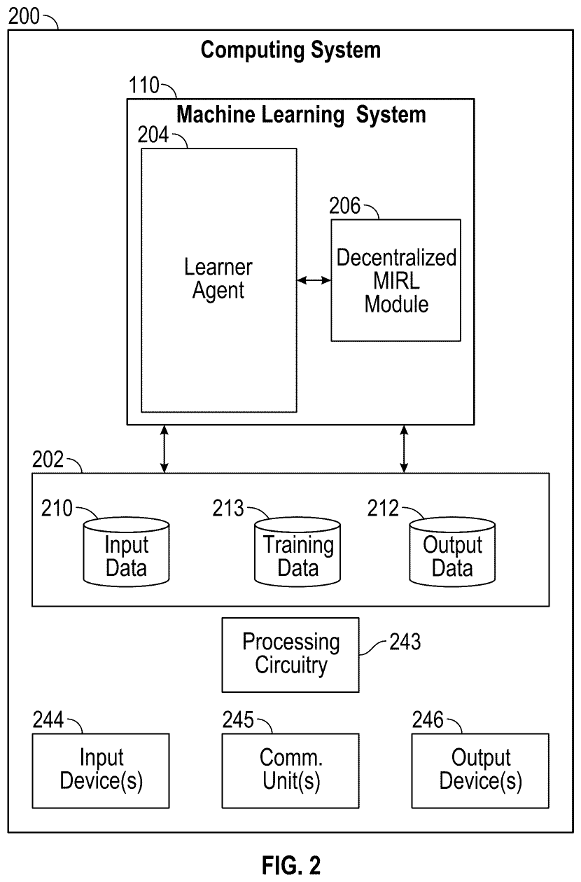

FIG. 2 is a block diagram illustrating an example computing system 200. In an aspect, computing system 200 may represent an example of any of team member platforms 102, 104, 106, 108 or team management module 112 shown in FIG. 1. As shown, computing system 200 includes processing circuitry 243 and memory 202 for executing a machine learning system 110 that may be a component of a team management module 112 and/or a component of each of the plurality of team management platforms 102, 104, 106, 108. Alternatively, machine learning system 110 may be implemented on a system separate from the collaborative team environment 100 shown in FIG. 1.

Computing system 200 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent cloud computing system, a server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. In some examples, at least a portion of system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 243 of computing system 200 may implement functionality and/or execute instructions associated with computing system 200. Computing system 200 may use processing circuitry 243 to perform operations in accordance with one or more aspects of the present disclosure using software, hardware, firmware, or a mixture of hardware, software, and firmware residing in and/or executing at computing system 200. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Memory 202 may comprise one or more storage devices. One or more components of computing system 200 (e.g., processing circuitry 243, memory 202) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., learner agent 204, decentralized MIRL module 206), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute machine learning system 110 using virtualization modules, such as a virtual machine or container executing on underlying hardware. One or more of such modules may execute as one or more services of an operating system or computing platform. Aspects of machine learning system 110 may execute as one or more executable programs at an application layer of a computing platform.

One or more input devices 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 may include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, machine learning system 110 may receive input data from an input data set 210 and may generate output data 212. Input data 210 and output data 212 may contain various types of information, which will generally be tailored to the application/use case for the collaborative team environment. When used in the example system of FIG. 1, input data 210 may include sensor data, output data from other team members, environment information, a set of demonstrated/observed team behaviors (trajectories), each corresponding to sequences of state and joint action (team behavior) pairs, and the like. Input data 210 may also include a set of baseline profiles. A set of baseline profiles may encode domain-specific, notional preferences and goals in the task. Output data 212 may include information such as, but not limited to (i) one or more reward functions and/or (ii) best response strategies conditioned on the perceived models of other team members.

Machine learning system 110 may process training data 213 to train the learner agent 204, in accordance with techniques described herein. For example, machine learning system 204 may apply an end-to-end training method that includes processing training data 213 in a supervised manner. Training data 213 may include, but is not limited to, agent behavior data and ground-truth targets/labels. The inferred rewards may be compared against this ground truth labels to measure accuracy of the model. Since directly measuring human goals may be difficult, training data 213 may also include pre- and post-task surveys that may be used to assess individual motivations and strategies. The surveys may provide an indirect measure of how well machine learning system 204 captures human goals.

Reinforcement Learning relies heavily on Markov Decision Processes (MDPs) to model decision-making scenarios for agents interacting with an environment. For example, an MDP may be defined by a set of elements represented as a tuple <S, A, T, R, γ>.

S (States) may represent a finite set of all possible states the agent may be in. A (Actions) may represent a finite set of all possible actions the agent can take. T (Transition Probability) may describe the probability (Pr) of transitioning from state s to state s′ after taking action a. The transition probability may be denoted as T(s′, a, s).

R (Reward) may represent the immediate reward the agent receives for being in state s and taking action a. The reward may be denoted as R(s, a).

γ (Discount Factor) may represent a value between 0 and 1 that determines how much future rewards are valued compared to immediate rewards. Higher discount factor values may prioritize long-term rewards.

The Bellman equation is a fundamental concept in RL. The Bellman equation defines the optimal Q-value, denoted as Q*(s, a), which represents the expected future reward an agent may get by taking action a in state s and following the optimal policy thereafter.

The following is the Bellman equation (1):

$${Q}^{*} ( s , a ) = ( s , a ) + {γ𝔼}_{{s}^{′} ∼ T} [ max {Q}^{*} ( {s}^{′} , {a}^{′} ) ] \qquad ( 1 )$$

where, E denotes the expectation over all possible next states s′ that could be reached after taking action a in state s, and a′ represents the optimal action to take in the next state s′. The optimal policy, denoted as π*(s), refers to the mapping from states to actions that maximizes the expected future reward. The optimal policy may be found using the Q-values, as shown in the following equation (2):

$${π}^{*} = arg {max}_{a} {Q}^{*} ( s , a ) \qquad ( 2 )$$

It should be noted that the equation (2) essentially chooses the action a in state s that leads to the highest expected future reward according to the Q-values.

In regular RL, an agent learns an optimal policy (way of acting) to maximize reward of the agent in an environment. The reward function may be predefined.

IRL takes the opposite approach. Given an observed behavior of an agent (trajectories of state-action pairs) and the environment dynamics (states, actions, transitions), IRL aims to recover the reward function that likely motivated the behavior of an agent. In addition to (S), (A), and (T) defined above, IRL may receive demonstrated trajectories (D). The demonstrated trajectories may represent a collection of sequences showing the state-action pairs of an agent over time.

The goal of IRL is to find the reward function parameters (θ) that best explain the observed demonstrations. In an example, Maximum Entropy IRL (MaxEnt IRL) may be used as a method for uncovering the reward function. MaxEnt IRL leverages the principle of maximum entropy, which favors solutions that are not overly specific. In the context of IRL, maximum entropy means finding a reward function that explains the observed behaviors well but does not make unnecessary assumptions about other possible behaviors the agent could have taken. High entropy means the reward function allows for a variety of behaviors consistent with the observed behaviors.

MaxEnt IRL may iteratively search for the reward function parameters (θ*), such that: the reward function parameters maximize the expected reward of the demonstrated trajectories and the probability of observing a particular trajectory is proportional to the sum of its rewards along the path. Essentially, the more rewarding a path is, the more likely the agent was to take it (following the principle of maximizing expected reward). MaxEnt IRL uses the principle of maximum entropy to find a reward function that explains the observed behaviors while remaining agnostic to specific choices the agent might have made.

As noted above, IRL aims to recover the reward function (motivations) of an individual agent by observing their past behavior. MIRL builds on this concept to understand teams. Similar to IRL, MIRL may receive data in the form of trajectories. However, in case of MIRL, each trajectory may represent a sequence of state-joint action pairs over time for the entire team. For example, a joint action may specify the action taken by each individual team member at each time step. Unlike single-agent IRL, MIRL aims to recover the reward function for every member of the team. MIRL may search for a set of reward function parameters (Θ*) that best explains the observed team trajectories.

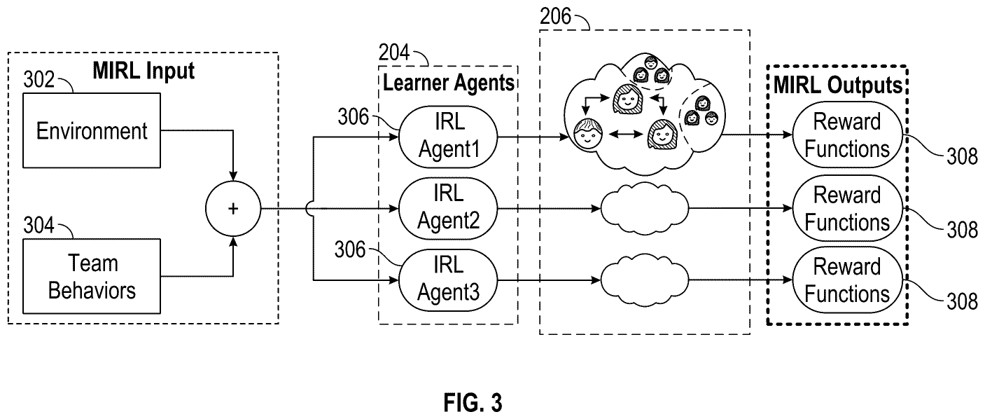

FIG. 3 is a conceptual diagram illustrating an overview of Multiagent Inverse Reinforcement Learning via Theory of Mind reasoning (MIRL-ToM) framework according to techniques of this disclosure. Machine learning system 204 may observe the environment 302 and the actions 304 taken by a team during a task. Each learner agent 204 may use decentralized MIRL module 206 to analyze the behavior of other agents. Decentralized MIRL module 206 may allow the learner agents 204 to infer the mental states (goals, intentions) of others. Each learner agent 204 may perform single-agent IRL 306, but instead of just considering its own actions, learner agent 204 may factor in its understanding of goals of other agents derived by decentralized MIRL module 206. Through the process illustrated in FIG. 3, each learner agent 204 may infer a reward function 308 that best explains its own and observed behavior of other teammates. The technique illustrated in FIG. 3 is a decentralized technique. In other words, each learner agent 204 may learn independently but may consider the actions of a team through MIRL module 206.

In simpler terms, decentralized MIRL module 206 may seek a combination of individual reward functions 308 that best explain the observed joint actions of the team members throughout the trajectories. Unlike single-agent IRL 306, decentralized MIRL module 206 may face additional challenges due to team dynamics. In the context of MIRL, the assumption is that the behavior of the team reflects some form of equilibrium (like Nash equilibrium where each member acts in their own best interest). Just like single-agent IRL 306, there may be multiple reward function 308 combinations that explain the behavior of the team.

Many current MIRL approaches rely on a centralized learner that assumes perfect information about the team. In other words, the centralized learner may know the reward function (individual preferences) of each team member. The centralized learner may compute the joint action equilibrium at each time step based on the known reward functions. Essentially, the centralized learner may assume all team members perfectly understand goals of each other and may act accordingly throughout the task. However, the aforementioned assumption may be unrealistic in many real-world hybrid team scenarios due to several reasons. People often collaborate with teammates they do not know well. This lack of initial knowledge about goals and preferences of a teammate makes perfect information substantially unrealistic. Even with observation, true intentions of a teammate may be misinterpreted due to the inherent variability of human behavior. Humans may leverage their social intelligence to understand the intentions and actions of other agents (human or AI) based on nonverbal cues or subtle communication. The aforementioned information may be integrated into the corresponding belief updates. AI agents may process vast amounts of sensor data and past interactions to update their belief distributions about the environment and actions of other agents. In an example, AI agents may share these insights with human teammates. As team members adapt their behavior to each other throughout the task, their initial assumptions and the overall equilibrium may change dynamically. Such change may make the “stationary equilibrium” assumption unrealistic.

To address the aforementioned limitations, the disclosed techniques may borrow the concept of Theory of Mind (ToM) from cognitive science.

In an aspect, learner agent 204 may use ToM reasoning to update a probability distribution (belief) over baseline profiles given the behavior of the agent in the trajectories. ToM may allow learner agent 204 to attribute mental states (beliefs, desires, intentions) to others to explain and predict their actions. In this context, MIRL may be enhanced with ToM by modeling each team member as adapting to behavior of other teammates. Each team member may maintain a probability distribution over baseline profiles.

The baseline profiles may represent different “personalities” or behavioral tendencies relevant to the task (e.g., prioritizing rescuing victims vs. communication in a disaster scenario). As the task unfolds and interactions occur, the probability distribution over baseline profiles may be updated by learner agent 204. In many cases, by observing actions of teammates, learner agent 204 of each member may refine their belief about which baseline profile best describes behavior of each teammate.

Learner agent 204 may link the baseline profiles to domain-specific reward models. The domain-specific reward models may represent different reward preferences for achieving goals or avoiding penalties in the task.

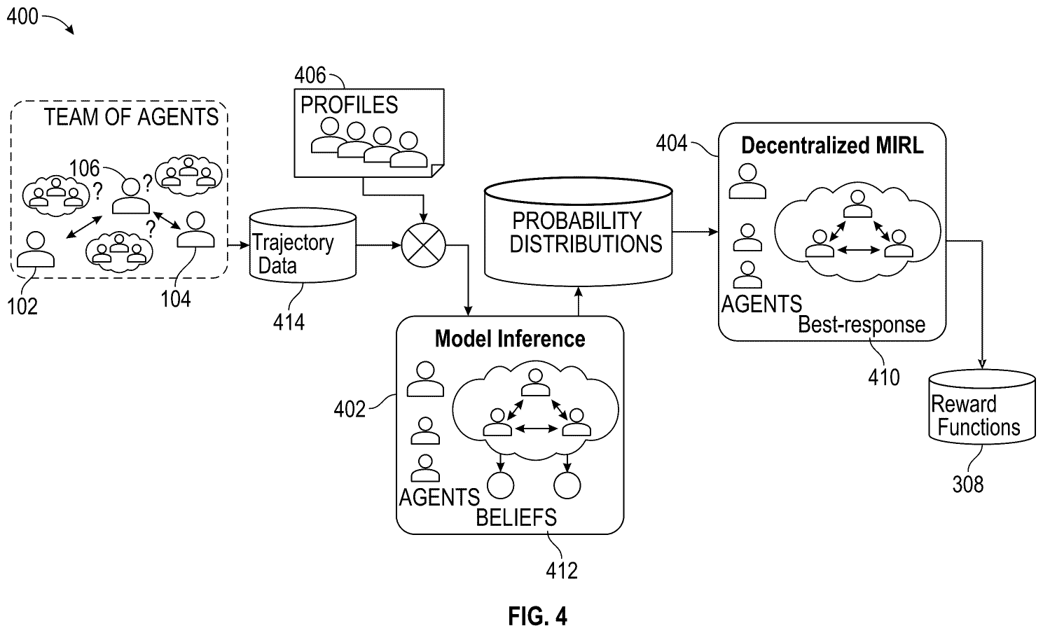

After each learner agent 204 computes (time-varying) beliefs about the expected motivations of the teammates, decentralized MIRL module 206 may perform decentralized MIRL by computing reward function 308 for each individual agent separately, as discussed in greater detail below in conjunction with FIG. 4.

In summary, machine learning system 110 may be a platform designed to model social simulations using decision-making agents with ToM. Machine learning system 110 may create learner agents 204 that make decisions based on a theoretical framework considering risks and rewards. The generated learner agents 204 may be equipped with ToM, allowing them to reason about the mental states (beliefs, desires) of other agents. Thoughts, feelings, and motivations of a human are internal and not directly observable. Learner agents 204 may only infer the mental states through observed behavior, communication, or physiological cues. The reward function 308 may be based on the actions the human takes, not their motivations. For instance, in a search and rescue mission, the reward may be higher for rescuing a survivor quickly, regardless of whether the human agent is motivated by a sense of duty, competition, or empathy. Furthermore, machine learning system 204 may construct an “agent mind” recursively. In other words, each learner agent 204 may have its own reward function 308 (motivations). Each learner agent 204 may build models of other agents, including their reward functions 308.

Essentially, learner agents 204 may develop an understanding of themselves and how they perceive others.

Machine learning system 110 may utilize two types of environments for social simulations. Markov games may represent situations where all learner agents 204 may observe the entire state of the environment 302. Additionally, Multiagent Partially Observable Markov Decision Processes (MPOMDPs) may be more complex environments where learner agents 204 have limited information about the overall state and may rely on observations to make decisions. In other words, MPOMDP is a framework for modeling situations where multiple agents are working together in environment 302 with some level of uncertainty. For example, if a team of robots is cleaning a house, each robot is an agent in this MPOMDP. The robots may not see the entire house at once. Maybe, there are dusty corners or furniture blocking their view.

Observations of the robots may be limited to their surroundings. At each step, each learner agent 204 may consider all possible actions for itself and other agents.

As noted above, using ToM, the learner agent 204 may estimate the action values for other agents, assuming they are also trying to maximize their rewards based on the model the first agent has of them. Finally, the learner agent 204 may make its own decision by considering the potential rewards and risks associated with each action 304, while also planning for the future based on a specified time horizon. Machine learning system 110 may acknowledge the inherent uncertainty in social interactions. In an aspect, learner agents 204 may form beliefs about the state of the environment 302 (e.g., is it safe to proceed?). Learner agents 204 may also form beliefs about the internal models of other agents (e.g., what are their goals?).

FIG. 4 is a conceptual diagram illustrating two phases of the MIRL-ToM framework, according to techniques of this disclosure. As shown in FIG. 4 MIRL-ToM framework 400 could have two phases: model inference 402 that may be performed by learner agent 204 and decentralized MIRL 404 that may be performed by decentralized MIRL module 206.

Advantageously, the first phase (model inference 402) may focus on how each team member uses ToM reasoning to understand motivations of their teammates based on observed behavior. Learner agent 204 of each team member platform 102, 104, 106, 108 may try to figure out how their teammates might be perceiving them based on actions. In one non-limiting example, each learner agent 204 may maintain a probability distribution over baseline profiles for every other teammate.

It may be difficult for learner agents 204 to understand how teams coordinate their actions without explicit communication. Learner agent 204 may need to reason about goals and intentions of each other. Learner agents 204 may make decisions based on their own motivations while considering behavior of other team members (learner agents 204).

To address the aforementioned challenge, learner agents 204 may utilize a set of baseline agent profiles. As noted above, the baseline profiles 406 may represent different behavioral tendencies relevant to the specific task at hand. For example, in a search-and-rescue scenario, the baseline agent profiles 406 might include searching for victims' profiles, providing medical aid (triage) profiles, or calling for backup profiles. More specifically, the baseline profiles 406 may be seen as encodings of different agent decision-making models. According to the disclosed techniques, the baseline profiles 406 may be specifically linked to reward functions 308. In other words, each baseline profile 406 may represent an agent with a particular set of goals and priorities. As noted above, before a task begins, each team member may assume their teammates will behave according to a probability distribution over the baseline profiles. The initial distribution could be uniform (all profiles equally likely) or based on any available background information.

In an aspect, as the task progresses, each team member platform 102, 104, 106, 108 may observe the actions 304 of their teammates. Each learner agent 204 of the corresponding team member platform 102, 104, 106, 108 may then update their belief (probability) distribution for each teammate using ToM reasoning. In an example, by observing actions 304, each team member platform 102, 104, 106, 108 may refine their understanding of which baseline profile 406 best describes behavior of each teammate. The MIRL-ToM techniques disclosed herein contemplate a framework for reasoning about behavior of other agents during a task.

In an example, by observing actions 304, each team member may refine their belief 412 about which baseline profile 406 best describes behavior of each teammate. Essentially, the model inference phase 402 may capture how each team member builds a model of motivations of their teammates through observation.

The second phase (decentralized MIRL 404) may leverage the understanding from the first phase to learn individual reward functions 308 for each team member. Similar to previous approaches, MIRL may be broken down into separate problems for each team member. Decentralized MIRL module 206 may infer the reward function 308 of each member platform 102, 104, 106, 108 using a technique called MaxEnt IRL based on their own observed behavior. During MaxEnt IRL, each team member platform 102, 104, 106, 108 may simulate the behavior of other team members based on the time-varying distribution over baseline profiles 406 obtained in the model inference phase 402.

In one non-limiting example, essentially, each team member platform 102, 104, 106, 108 may consider how their teammates might react based on their perceived motivations. By simulating teammates and considering their perceived motivations, each team member platform 102, 104, 106, 108 may find a “best response” strategy 410 for themselves. The best-response strategy 410 may aim to maximize their own reward (considering how others might behave). In other words, the term “best response strategy for an agent” means acting in a way that maximizes reward of an agent given the actions (or policies) of other agents. Overall, decentralized MIRL module 206 may use ToM-informed simulations to achieve decentralized MIRL, resulting in individual reward functions 308 that capture goals of each team member while considering the team dynamic. The key for the MIRL module 206 is to design reward functions 308 that encourage agents to consider both their individual rewards and the impact of their actions on the performance of the team.

In the context of the disclosed techniques, reward functions 308 of IRL may be seen as analogous to mental states in humans, representing their motivations. While ToM has been used in multiagent reinforcement learning (RL), application of ToM in MIRL, specifically for understanding team motivations, is a novel concept.

As noted above, MIRL-ToM framework 400 may allow for learning individual reward functions 308 for each team member, similar to decentralized MIRL approaches. MIRL-ToM framework 400 may handle situations where team members (e.g., team member platforms 102, 104, 106, 108) are initially unknown by assuming a set of baseline reward profiles 406 representing different behavioral tendencies. MIRL-ToM framework 400 may tackle the challenge of teammate intention uncertainty by employing Bayesian ToM reasoning over the baseline profiles 406. Overall, MIRL-ToM framework 400 offers a new way to understand team behavior in MIRL settings. The disclosed framework 400 allows for analyzing teams with unknown compositions by considering both individual actions and how team members interpret behavior of each other through ToM reasoning.

Still referring to FIG. 4, in a non-limiting example, the beliefs 412 generated by learner agents 204 may be constantly updated using Bayesian inference as the learner agent 204 makes observations and gathers information through state features (visible aspects of the environment 302) and the actions 304 of other agents.

As noted above, as the team progresses through a task (reflected in the trajectory data 414), each learner agent 204 may observe the actions 304 of their teammates.

Different team members may have different initial belief distributions about each other. The initial belief may be represented by a prior distribution over the models (reward profiles) of the other agents, which is denoted by b^{k}(m) for each other agent k. Each agent may acknowledge there is uncertainty about the true reward function driving behavior of other agents. There could be multiple explanations (models) for why someone acts the way they do. The agent may assign a probability to each possible model. For instance, one model might be that another agent is highly cooperative, while another model might be that they prioritize finishing the task quickly, even if it means sacrificing some cooperation. The agent would assign a probability to how likely the agent expects each scenario to be. As the agents interact and observe each other's actions, they may update corresponding probability distributions. For example, if an agent consistently acts cooperatively, the probability assigned to the “cooperative” model would increase. For each step of each trajectory (i, the model distribution b^{k}(m) is updated via a Bayesian inference equation. The prior distribution may assign probabilities to different possibilities (e.g., different possible actions). The following Bayesian inference equation (Equation 3) may be used to update teammates belief distribution for each reward profile of a teammate based on the observed actions:

$${b}^{′} ( m ) ∝ P r ( a \vert m , ζ ) \times b ( m \vert ζ ) \qquad ( 3 )$$

Essentially, each learner agent 204 may refine its understanding of which baseline profile 406 best describes behavior of each teammate by considering how likely that profile would generate the observed actions. Each learner agent 204 may consider a prior belief (the initial belief) and the new observed behavior to calculate a posterior distribution. The posterior distribution is the updated belief about which baseline profile 406 best describes behavior of each teammate, taking the newly observed behavior into account. After the Bayesian update, the learner agent 204 may enrich team trajectories 414. Each step in the trajectory 414 may now include not just the state and joint action but also the updated belief distribution of the agent over the reward profiles of a teammate. In other words, each learner agent 204 may carry a “mental map” of the world around them. The “mental map” may not be perfect. The map may reflect the limited observations and understanding of the learner agent 204. A belief distribution captures this uncertainty. The belief distribution may assign probabilities to different possibilities about the state of the environment 302, the actions 304 of other learner agents 204, and anything else relevant to decision-making.

In an example, the belief update process may also vary depending on the specific observations each team member makes. For instance, some learner agents 204 may only observe local interactions with a teammate, while others may have a more global view.

The decentralized MIRL phase 404 may rely on the time-varying belief distributions about motivations of teammates obtained in model inference phase 402. Each team member (learner agent 204) may now have a refined understanding of what motivates their teammates based on observed actions. As noted above, the decentralized MIRL module 206 may employ a decentralized approach to MIRL. In other words, in the second phase (decentralized MIRL) 404, decentralized MIRL module 206 may infer the reward function 308 for each agent separately.

The disclosed techniques may assume a specific form for the reward function 308, as shown in the following equation (4):

$$R ( s , a ) := {θ}^{T} ϕ ( s , \hat{a} ) \qquad ( 4 )$$

where R(s, a) represents the reward an agent receives in state s for taking action a, θ is a vector of reward weights, and ϕ(s, â) is a vector of reward features that depend on the state s and the joint action â of the team.

In an example, the reward function 308 may be a linear combination of reward features weighted by specific parameters θ.

In summary, the MIRL-ToM framework 400 may utilize the principle of maximum entropy to find the reward function 308 for each agent. The principle of maximum entropy may ensure that the solution may not be overly specific and may allow for flexibility. In other words, the goal of decentralized MIRL module 206 may be to find the reward weights (θ*) that maximize the probability of observing the actual trajectories (D) of an agent given their beliefs (b(m)) about motivations of their teammates.

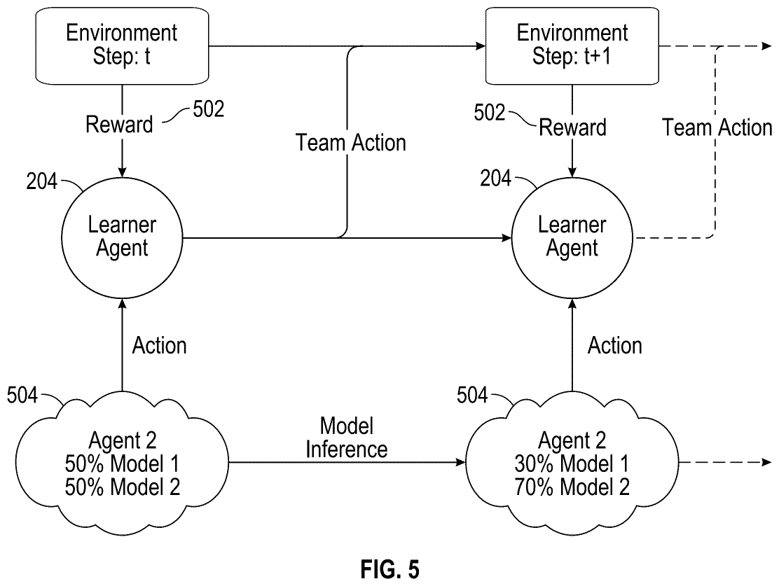

FIG. 5 is a conceptual diagram illustrating learning techniques of multiple agents (a “team”) to cooperate and achieve a common goal based on expert demonstrations, according to techniques of the present disclosure. The disclosed techniques employ decentralized equilibrium computation with MaxEnt IRL extension.

MaxEnt IRL is a technique used to infer the reward function (what the agents are trying to achieve) from observed expert behavior. Each agent may learn a reward function considering the perceived behavior of other agents. Each agent may learn independently without needing all agents to be together.

First, each learner agent 204 may estimate a distribution over possible models describing the behavior of other agents. Next, based on the current reward function guess 502 and the estimated model of other agents 504, each learner agent 204 may compute the best course of action (policy). Using simulations, each learner agent 204 may estimate the features (characteristics) of trajectories it would take given its current policy and the estimated policies of others. Finally, each learner agent 204 may adjust its reward function guess 502 to make the estimated features match the features observed in the expert demonstrations. Advantageously, each learner agent 204 may learn independently. In other words, the learning process illustrated in FIG. 5 may be parallelizable. Individual reward functions 308 may be designed to take into account not just the local reward of the learner agent 204 but also the impact of actions of the learner agent 204 on the goal of the team. Decentralized equilibrium may involve adding terms to the reward function that penalize actions detrimental to the team or reward actions that benefit the team even if they may not directly benefit the individual learner agent 204.

In summary, collaboration may not benefit everyone equally, leading to conflicts or reduced motivation. People may not fully understand biases and preferences of their teammates, hindering effective interaction. Team dynamics may change over time, requiring constant adaptation.

It should be noted that AI is increasingly used in various sectors and various industries. Future complex tasks will likely involve human-AI collaboration. For trustworthy collaboration AI agents may need to understand both human and machine teammates. The disclosed techniques that may be implemented by machine learning system 110 leverage the fact that AI agents are capable of predicting how teammates will act during collaboration. In other words, understanding why teammates behave the way they do may be important for trustworthy collaboration. In an example, AI agents may need to adjust their behavior based on perceived changes in the team.

Furthermore, ToM allows AI agents to understand and predict the behavior of other agents (human or machine) by considering their mental states (goals, beliefs, intentions).

Existing ToM-based AI models primarily focus on understanding one agent at a time. The existing models may struggle to reason about how multiple agents, with different goals, adapt to behavior of each other in a dynamic setting. Most ToM-based solutions are limited to small, controlled environments with simple interactions. The aforementioned limitations make it difficult for AI agents to effectively collaborate with humans in complex tasks. Existing MIRL approaches rely on a central controller, which may become impractical for complex scenarios with humans. The disclosed techniques update beliefs of learner agent 204 about goals and strategies of the teammates (human or machine) as they work together on a task. Each learner agent 204 may estimate the intentions of its teammates based on their observed behavior (similar to Theory of Mind). Such estimation may consider the own goals of the learner agent 204 (adding a recursive layer where the agent reasons about how others might think). Machine learning system 110 may employ a decentralized MIRL technique. In other words, each learner agent 204 may independently calculate the best course of action for itself. The learner agent 204 may calculate the best course of action based on the understanding of the goals of teammates. Furthermore, the learner agent 204 may calculate the best course of action based on the need to reach a joint equilibrium (a stable state where everyone is “happy” with their actions).

Additionally, the machine learning system 110 may analyze existing data containing past team behaviors to identify general tendencies of individual agents and teams.

Machine learning system 110 builds on MIRL-ToM framework 400 to tackle real-world, complex collaboration between humans and AI agents.

The disclosed techniques may leverage Machine ToM (ToMnet), which is a neural network that efficiently models the behavior of others (“on the fly”).

The disclosed techniques may integrate ToMnet within the decision-making process to perform deeper and more dynamic reasoning about intentions of the teammates.

As noted above, the AI agents that use ToMnet may simultaneously understand the goals and strategies of multiple teammates.

During task execution (online), AI agents may learn how to collaborate with multiple teammates by observing their behavior. Such collaboration may be achieved through recursive Bayesian ToM of the machine learning system 110 which may reason about intentions of teammates based on observations. Machine learning system 110 may go beyond simply communicating intentions. The machine learning system 110 may allow AI agents to communicate expectations about their behavior, aligning with how humans reason by leveraging the symbolic reasoning capabilities of ToM.

It should be noted that when working with teammates, there is always some uncertainty about their goals and preferences. Machine learning system 110 addresses this issue by employing probabilistic reasoning to account for such uncertainties.

In an example, the reasoning capabilities of machine learning system 110 disclosed herein may extend to adversarial settings. The machine learning system 110 may reason about not only cooperative behavior but also competitive behavior, resulting in groups of agents with mixed intentions (collaboration/competition).

As noted above, in an example, AI agents implementing the disclosed techniques may effectively collaborate with humans on complex tasks. In other words, the AI agents may be able to understand goals and intentions of their human teammates. Advantageously, the AI agents may also be able to predict how humans will behave. In an example, AI agents may be able to adapt their own behavior to work well with humans.

Referring back to FIG. 1, one or more team member platforms 102, 104, 106, and 108 implemented as an AI agent may use Bayesian ToM of machine learning system 110 to learn about preferences and intentions of each team member platform 102, 104, 106, and 108. Team management module 112 may also use Bayesian ToM of machine learning system 110 to monitor team performance and anticipate individual behavior. In an example, team management module 112 may use the Bayesian ToM to reason about how team members understand actions of each other. Based on such understanding, the team management module 112 may encourage struggling team members. The team management module 112 may also warn the team about potential misunderstandings that could hinder coordination.

More specifically, AI teammates may continuously update their beliefs about teammate preferences.

Based on the updated beliefs, the AI teammates may adapt their behavior to best complement their human teammates. The AI teammates may also use the updated beliefs to choose actions that maximize the overall team benefit (joint gains). Each agent may choose to perform actions that not only maximize its own reward but also complement the actions of others, leading to a higher overall team benefit.

Machine learning system 110 aims to improve teamwork by addressing issues that lead to suboptimal coordination in human teams. Time pressure, cognitive overload, and uncertainty may hinder ability of human team members to fully reason about each other. Humans may struggle to perform Theory of Mind reasoning about multiple unknown teammates, considering their potential reasoning processes (recursive ToM).

The disclosed techniques may be used in a variety of industries. As a non-limiting example, surgeons may leverage surgical robots powered by machine learning system 110 that adapt to their plans in real-time, potentially leading to improved surgical outcomes.

AI-powered agents controlling heavy machinery could use machine learning system 110 to understand and adapt to actions of human construction workers, enhancing safety on construction sites. Machine learning system 110 may be used to create AI systems that coordinate search-and-rescue teams more effectively. AI-powered tools with capabilities of the disclosed machine learning system 110 may guide disaster relief operations by understanding and adapting to the needs of human responders.

In one example, machine learning system 110 may use POMDP, a mathematical framework, to model the decision-making process of multiple agents (humans and AI) working together on a task.

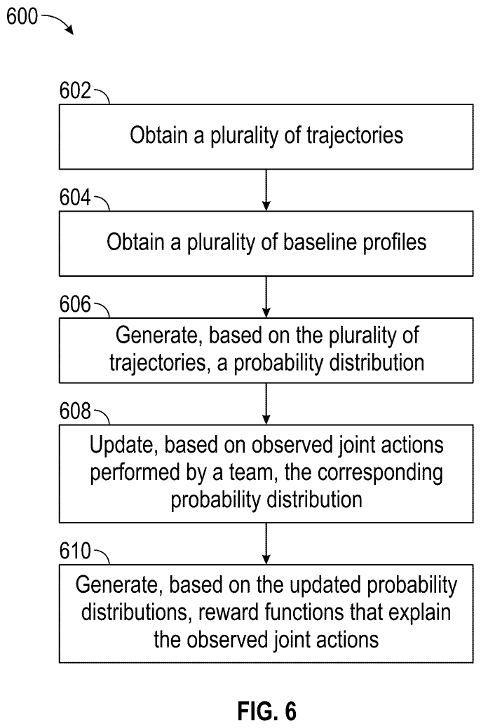

FIG. 6 is a flowchart illustrating an example mode of operation for a machine learning system, according to techniques described in this disclosure. Although described with respect to computing system 200 of FIG. 2 having processing circuitry 243 that executes machine learning system 110, mode of operation 600 may be performed by a computation system with respect to other examples of machine learning systems described herein.

In mode operation 600, processing circuitry 243 executes machine learning system 110. Machine learning system 110 may obtain a plurality of trajectories 414 representing a behavior of a team comprising a plurality of agents and may obtain a plurality of baseline profiles 406 (602). As used herein, the term “obtaining” may include receiving this data or generating the data. Each of the plurality of trajectories 414 may represent a sequence of state-joint action pairs over time for the team. Next, machine learning system 110 may obtain a plurality of baseline profiles 406 (604). Each of the plurality of baseline profiles 406 may describe preferences and goals of the agent for the task the team is working on. Machine learning model 110 may generate, based on the data indicating the plurality of trajectories, a probability distribution of each agent of the plurality of agents over the plurality of baseline profiles (606). The probability distribution of each agent may describe a behavior of the agent. By analyzing the trajectories 414, machine learning system 110 of each agent may try to figure out what the others value and aim for based on past teamwork experiences. Next, machine learning system 110 may update, based on one or more observed joint actions performed by the team, the corresponding probability distribution of each agent of the plurality of agents (608). As the team works together, the agents may learn to adjust their understanding of goals and preferences of each other. Machine learning system 110 may also generate, based on the updated probability distributions of the plurality of agents, one or more reward functions 308 that explain the observed one or more joint actions performed by the team (610). Each of the one or more reward functions 308 corresponds to each of the plurality of agents. The generated reward function 308 may essentially explain why the team took the actions it did, considering individual perspective of each agent.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The phrase “A and/or B,” as used herein, includes A, B, or both A and B.

The techniques described in this disclosure may also be embodied or encoded in computer-readable media, such as a computer-readable storage medium, containing instructions.

Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method for team modeling, the method comprising:
obtaining data indicating a plurality of trajectories representing a behavior of a team comprising a plurality of agents;
obtaining a plurality of baseline profiles, wherein each of the plurality of baseline profiles encodes at least one of a preference and/or a goal that is relevant to a task performed by the team;
generating, based on the data indicating the plurality of trajectories, a probability distribution of each agent of the plurality of agents over the plurality of baseline profiles, wherein the probability distribution of each agent describes a behavior of the agent;
updating, based on one or more observed joint actions performed by the team, the corresponding probability distribution of each agent of the plurality of agents; and
generating, based on the updated probability distributions of the plurality of agents, one or more reward functions that explain the observed one or more joint actions performed by the team, wherein each of the one or more reward functions describes the behavior of a corresponding one of the plurality of agents.

2. The method of claim 1, wherein each of the plurality of trajectories is represented as a sequence of state-joint action pairs over time.

3. The method of claim 1, wherein generating one or more reward functions that explain the observed one or more joint actions performed by the team comprises:
generating the one or more reward functions based on the obtained sequence of state-joint action pairs and observed environment dynamics.

4. The method of claim 3, wherein generating one or more reward functions that explain the observed one or more joint actions performed by the team comprises:
generating the one or more reward functions using inverse reinforcement learning method.

5. The method of claim 4, wherein generating one or more reward functions that explain the observed one or more joint actions performed by the team comprises:
generating one or more reward weights that maximize the probability of observing actual trajectories of an agent given the updated probability distributions of the plurality of agents.

6. The method of claim 1, wherein the team operates in a Multiagent Partially Observable Markov Decision Processes environment.

7. The method of claim 1, wherein generating the one or more reward functions comprises generating the one or more reward functions to achieve decentralized equilibrium.

8. The method of claim 1, further comprising:
performing an action that maximizes a team benefit based on the one or more reward functions.

9. The method of claim 1, wherein the team comprises a hybrid team that includes one or more human agents and one or more Artificial Intelligence agents.

10. The method of claim 9, wherein the generated one or more reward functions represent one or more motivations, intentions, goals of the one or more agents.

11. A computing system for team modeling, the computing system comprising:
processing circuitry in communication with storage media, the processing circuitry configured to execute a machine learning system configured to:
obtain data indicating a plurality of trajectories representing a behavior of a team comprising a plurality of agents;
obtain a plurality of baseline profiles, wherein each of the plurality of baseline profiles encodes at least one of a preference and/or a goal that is relevant to a task performed by the team;
generate, based on the data indicating the plurality of trajectories, a probability distribution of each agent of the plurality of agents over the plurality of baseline profiles, wherein the probability distribution of each agent describes a behavior of the agent;
update, based on one or more observed joint actions performed by the team, the corresponding probability distribution of each agent of the plurality of agents; and
generate, based on the updated probability distributions of the plurality of agents, one or more reward functions that explain the observed one or more joint actions performed by the team, wherein each of the one or more reward functions describes the behavior of a corresponding one of the plurality of agents.

12. The system of claim 11, wherein each of the plurality of trajectories is represented as a sequence of state-joint action pairs over time.

13. The system of claim 11, wherein the machine learning system configured to generate one or more reward functions that explain the observed one or more joint actions performed by the team is further configured to:
generate the one or more reward functions based on the obtained sequence of state-joint action pairs and observed environment dynamics.

14. The system of claim 13, wherein the machine learning system configured to generate the one or more reward functions is further configured to:
generate the one or more reward functions using inverse reinforcement learning method.

15. The system of claim 14, wherein the machine learning system configured to generate one or more reward functions is further configured to:
generate one or more reward weights that maximize the probability of observing actual trajectories of an agent given the updated probability distributions of the plurality of agents.

16. The system of claim 11, wherein the team operates in a Multiagent Partially Observable Markov Decision Processes environment.

17. The system of claim 11, wherein the machine learning system configured to generate the one or more reward functions is further configured to:
generate the one or more reward functions to achieve decentralized equilibrium.

18. The system of claim 11, wherein the machine learning system is further configured to:
perform an action that maximizes a team benefit based on the one or more reward functions.

19. The system of claim 11, wherein the team comprises a hybrid team that includes one or more human agents and one or more Artificial Intelligence agents.

20. Non-transitory computer-readable storage media having instructions encoded thereon, the instructions configured to cause processing circuitry to:
obtain data indicating a plurality of trajectories representing a behavior of a team comprising a plurality of agents;
obtain a plurality of baseline profiles, wherein each of the plurality of baseline profiles encodes at least one of a preference and/or a goal that is relevant to a task performed by the team;
generate, based on the data indicating the plurality of trajectories, a probability distribution of each agent of the plurality of agents over the plurality of baseline profiles, wherein the probability distribution of each agent describes a behavior of the agent;
update, based on one or more observed joint actions performed by the team, the corresponding probability distribution of each agent of the plurality of agents; and
generate, based on the updated probability distributions of the plurality of agents, one or more reward functions that explain the observed one or more joint actions performed by the team, wherein each of the one or more reward functions describes the behavior of a corresponding one of the plurality of agents.
